(19) United States
(12) Patent Application Publication
(10) Pub. No.: US 2009/0031314 A1
(43) Pub. Date: Jan. 29, 2009

(54) FAIRNESS IN MEMORY SYSTEMS

(75) Inventors: Thomas Moscibroda, Redmond, WA (US); Onur Mutlu, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/782,719

(22) Filed: Jul. 25, 2007

(51) Int. Cl. G06F 9/46; G06F 12/00

(52) U.S. Cl. 718/102; 711/151; 711/E12.001

(57) ABSTRACT

Architecture for a multi-threaded system that applies fairness to thread memory request scheduling such that access to the shared memory is fair among different threads and applications. A fairness scheduling algorithm provides fair memory access to different threads in multi-core systems, thereby avoiding unfair treatment of individual threads, thread starvation, and performance loss caused by a memory performance hog (MPH) application. The thread slowdown is determined by considering the thread's inherent memory-access characteristics, computed as the ratio of the real latency that the thread experiences and the latency (ideal latency) that the thread would have experienced if it had run as the only thread in the same system. The highest and lowest slowdown values are then used to generate an unfairness parameter which when compared to a threshold value provides a measure of fairness/unfairness currently occurring in the request scheduling process. The architecture provides a balance between fairness and throughput.

### BACKGROUND

For many decades, the performance of processors has increased by hardware enhancements (e.g., increases in clock frequency and smarter structures) that improved single-thread (sequential) performance. In recent years, however, the immense complexity of processors as well as limits on power-consumption has made it increasingly difficult to further enhance single-thread performance. For this reason, there has been a paradigm shift away from implementing such additional enhancements. Instead, processor manufacturers have moved on to integrating multiple processors (“multi-core” chips) on the same chip in a tiled fashion to increase system performance power-efficiently.

In a multi-core chip, different applications can be executed on different processing cores concurrently, thereby improving overall system throughput (with the hope that the execution of an application on one core does not interfere with an application on another core). As cores on the same chip share the memory system (e.g., DRAM), memory access requests from programs executing on one core can interfere with memory access requests from program execution on a different core, thereby adversely affecting program performance.

Moreover, multi-core processors are vulnerable to a new class of denial-of-service (DoS) attacks by applications that can maliciously destroy the memory-related performance of another application running on the same chip. This type of application is referred to herein as a memory performance hog (MPH). While an MPH can be intentionally designed to degrade system performance, some regular and useful applications can also unintentionally behave like an MPH by exhibiting certain memory access patterns. With the widespread deployment of multi-core systems in commodity desktop and laptop computers, MPHs can become both a prevalent security issue and a prevalent cause of performance degradation that could affect almost all computer users.

In a multi-core chip, as well as SMP (symmetric shared-memory multiprocessor) and SMT (simultaneous multithreading) systems, the DRAM memory system is shared among the threads concurrently executing on different processing cores. By way of current memory system designs, it is possible that a thread with a particular memory access pattern can occupy shared resources in the memory system, preventing other threads from using those resources efficiently. In effect, the memory requests of some threads can be denied service by the memory system for long periods of time. Thus, an aggressive memory-intensive application can severely degrade the performance of other threads with which it is co-scheduled (often without even being significantly slowed down itself). For example, one aggressive application on an existing dual-core Intel Pentium D system can slow down another co-scheduled application by 2.9× while the MPH application suffers a slow-down of only 18%. In simulated multi-core system tests with a larger number (e.g., sixteen) of processing cores, the same application can slow down other co-scheduled applications by 14.6× while self-inflicting a slowdown by only 4.4×. This shows that, although already severe today, the problem caused by MPHs will become much more severe as processor manufacturers integrate more cores on the same chip in future multi-core systems.

The fundamental reason why application programs with certain memory request patterns can deny memory system service to other applications lies in the “unfairness” in the design of current multi-core memory systems. State-of-the-art DRAM memory systems service memory requests on a First-Ready First-Come-First-Serve (FR-FCFS) basis to maximize memory bandwidth. This scheduling approach is suitable when a single thread is accessing the memory system because it maximizes the utilization of memory bandwidth and is therefore likely to ensure fast progress in the single-threaded processing core. However, when multiple threads are accessing the memory system, servicing the requests in an order that ignores which thread generated the request can unfairly delay memory requests of one thread while giving unfair preference to other threads. As a consequence, the progress of an application running on one core can be significantly bogged down.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture describes how the memory system in a multi-threaded architecture (e.g., multi-core) can be implemented in such a way that access to the shared memory is fair among different threads and applications. A novel memory request scheduling algorithm provides fair memory access to different threads in multi-core systems, for example, and thereby mitigates the performance loss caused by an (intentional or unintentional) memory performance hog (MPH). Thus, the architecture provides enhanced security and robustness against unexpected performance losses in a multi-core system, and enhances performance fairness between different threads in a multi-core system. The architecture also avoids that some threads/applications starve and wait for associated memory requests to be served for an excessively long time.

The algorithm operates by receiving parameters (these parameters may either be fixed built-in or may be set adaptively/dynamically) that define fairness at any given time. Based on these parameters, the algorithm processes outstanding memory access requests using a baseline scheduling algorithm or the alternative fairness algorithm. The parameters can be provided either by system software or a bookkeeping component that computes these parameters based on request processing activities. In another embodiment, the parameters can be fixed in hardware.

The architecture dissects memory latency into two values: real latency (the latency inherent to the thread if run by itself) and ideal latency (the latency caused by contention with other threads in the shared memory system). The real and ideal latency values are used to determine a slowdown index. The highest and lowest slowdown index values are then used to generate a fairness parameter which when compared to a threshold value provides a measure of fairness/unfairness currently occurring in the request scheduling process.

The architecture provides a balance between fairness and throughput. Moreover, the architecture also deals with short-term fairness and long-term fairness by employing counters that increment based on time the thread executes. These aspects serve to defeat inter-thread interference in the memory system, denial-of-service (DoS) attacks, and improve fairness between threads with different memory access characteristics. This also serves to solve the problem of idle or bursty threads (a thread that has not issued memory requests for some time) from hogging memory resources after the thread stops being idle. In other words, the architecture balances the memory-related performance slowdown experienced by different applications/threads.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented memory management system for applying fairness to the scheduling of memory access requests in a shared memory system.

FIG. 2 illustrates an exemplary system that employs fairness in the scheduling of memory access requests in the shared memory system.

FIG. 3 illustrates a fair memory scheduling system that includes the fairness algorithm that achieves fairness by addressing performance slowdown.

FIG. 4 illustrates state in a system that includes the shared memory and structures for maintaining counts and state associated with fairness processing.

FIG. 5 illustrates state in the system that can occur when a memory bank in the shared memory becomes ready and a request in the request buffer is next to be served.

FIG. 6 illustrates state in the system that can occur when serving a next request.

FIG. 7 illustrates state in the system that can occur when serving a next request.

FIG. 8 illustrates fairness scheduling based on unfairness exceeding a predetermined threshold.

FIG. 9 illustrates fairness scheduling of FIG. 8 when serving a next request.

FIG. 10 illustrates a method of applying fairness in memory access requests.

FIG. 11 illustrates a method of enabling a fairness algorithm based on memory bus and bank state.

FIG. 12 illustrates a generalized method of managing memory access based on a baseline algorithm and a fairness algorithm.

FIG. 13 illustrates a more detailed method of employing fairness in memory access processing.

FIG. 14 illustrates a method of selecting the next request from across banks.

FIG. 15 illustrates a block diagram of a computing system operable to execute the disclosed fairness algorithm architecture.

### DETAILED DESCRIPTION

The disclosed architecture introduces a fairness component into shared memory systems by scheduling memory access requests of multiple threads fairly, in contrast to conventional algorithm that can unfairly prioritize some threads, be exploited by malware attacks (e.g., denial-of-service (DoS) attacks) or that can treat certain threads unfairly (by disproportionate slowdown) due to associated memory access characteristics. A fairness algorithm is employed that schedules outstanding memory requests in a transaction buffer (also referred to as a memory request buffer) in such a way as to achieve at least fairness and throughput:

Fairness: All threads should experience a similar slowdown due to congestion in the memory system, that is, requests should be scheduled in such a way that all threads experience more or less the same amount of slowdown.

Throughput: All slowdowns should be as small as possible in order to optimize the throughput in the memory system. The smaller a thread's slowdown, the more memory requests can be served and the faster the thread can be executed.

Current memory schedulers in multi-core systems attempt to solely optimize for memory throughput, and completely ignore fairness. For this reason, there can be very unfair situations in which some threads are starved and blocked from memory access, while at the same time other threads get almost as good a performance from the memory system as if each thread was running alone.

Superficially, these two goals (fairness and throughput) contradict. Current memory access schedulers are designed towards optimizing memory throughput and this is the reason why certain threads can be starved. However, in many cases, the disclosed scheduling architecture can provide fairness while actually improving application-level throughput in spite of a reduction in the memory system throughput. In other words, by providing fairness in the memory system, the total of the applications actually end up executing faster, although the number of requests per second that are served by the memory system may be reduced.

The reason is that by optimizing solely for memory system throughput (what conventional memory schedulers do), some threads may be unfairly prioritized and most of the requests served are by those threads—and other threads starve. The end result is that while some applications execute very speedily, others are very slow. Providing fairness in the memory system gives these overly slowed-down threads a chance to execute at a faster pace as well, which ultimately, leads to a higher total application-level execution throughput.

Following is a brief background description of DRAM memory system operation and terms that will be used throughout this description. A DRAM memory system consists of three major components: (1) the DRAM banks that store the actual data, (2) the DRAM controller (scheduler) that schedules commands to read/write data from/to the DRAM banks, and (3) DRAM address/data/command buses that connect the DRAM banks and the DRAM controller.

A DRAM memory system is organized into multiple banks such that memory requests to different banks can be serviced in parallel. Each DRAM bank has a two-dimensional structure, consisting of multiple rows and columns. Consecutive addresses in memory are located in consecutive columns in the same row. Each bank has one row-buffer and data can only be read from this buffer. The row-buffer contains at most a single row at any given time. Due to the existence of the row-buffer, modern DRAMs are not truly random access (equal access time to all locations in the memory array). Instead, depending on the access pattern to a bank, a DRAM access can fall into one of the three following categories:

1. Row hit: The access is to the row that is already in the row-buffer. The requested column can simply be read from or written into the row-buffer (called a column access). This case results in the lowest latency (typically 40-50 ns in commodity DRAM, including data transfer time, which translates into 120-150 processor cycles for a core running at 3 GHz clock frequency).

2. Row conflict: The access is to a row different from the one that is currently in the row-buffer. In this case, the row in the row-buffer first needs to be written back into the memory array (called a row-close) because the row access had destroyed the row's data in the memory array. Then, a row access is performed to load the requested row into the row-buffer. Finally, a column access is performed. Note that this case has much higher latency than a row hit (typically 80-100 ns or 240-300 processor cycles at 3 GHz).

3. Row closed: There is no row in the row-buffer. Due to various reasons (e.g., to save energy), DRAM memory controllers sometimes close an open row in the row-buffer, leaving the row-buffer empty. In this case, the required row needs to be first loaded into the row-buffer (called a row access). Then, a column access is performed. This third case is mentioned for sake of completeness; however, the focus herein is primarily on row hits and row conflicts, which have the greatest impact.

Due to the nature of DRAM bank organization, sequential accesses to the same row in the bank have low latency and can be serviced at a faster rate. However, sequential accesses to different rows in the same bank result in high latency. Therefore, to maximize bandwidth, current DRAM controllers schedule accesses to the same row in a bank before scheduling the accesses to a different row even if those were generated earlier in time. This policy causes unfairness in the DRAM system and makes the system vulnerable to DoS attacks.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

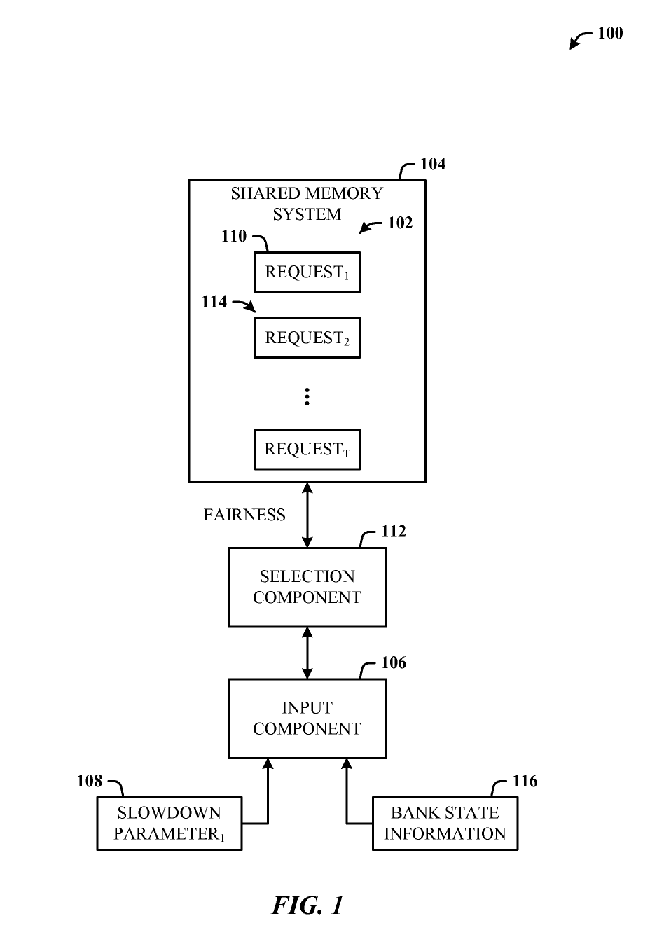

Referring initially to the drawings, FIG. 1 illustrates a computer-implemented memory management system 100 for applying fairness to the scheduling of memory access requests 102 in a shared memory system 104. The system 100 includes an input component 106 for receiving a slowdown parameter 108 (of a plurality of slowdown parameters) associated with a memory access request 110 (of the plurality 102 of corresponding memory access requests) in the shared memory system 104. The input component 106 receives thread-based unfairness parameters associated with performance slowdown of corresponding threads, where the performance slowdown is related to processing of the memory access requests 102 in the shared memory system 104.

A selection component 112 applies fairness (FAIRNESS) into scheduling of the request 110 relative to other access requests 114 based on the slowdown parameter 108. The input component 106 can also receive memory state information, for example, about the state of the memory system. For instance, the component 106 can receive bank state information 116 associated with memory banks (e.g., DRAM), such as which banks are ready and which rows are currently open (in a row buffer).

The input component 106 and the selection component 112 can be subcomponents of a scheduling component for scheduling outstanding memory access requests in the shared memory system 104. Optionally, other components can be included as part of the scheduling algorithm, as will be described herein.

The system 100 and other alternative and exemplary implementations described here are suitable for application to multi-core processor systems, as well as for SMP (symmetric shared-memory multiprocessor) systems and SMT (simultaneous multithreading) systems.

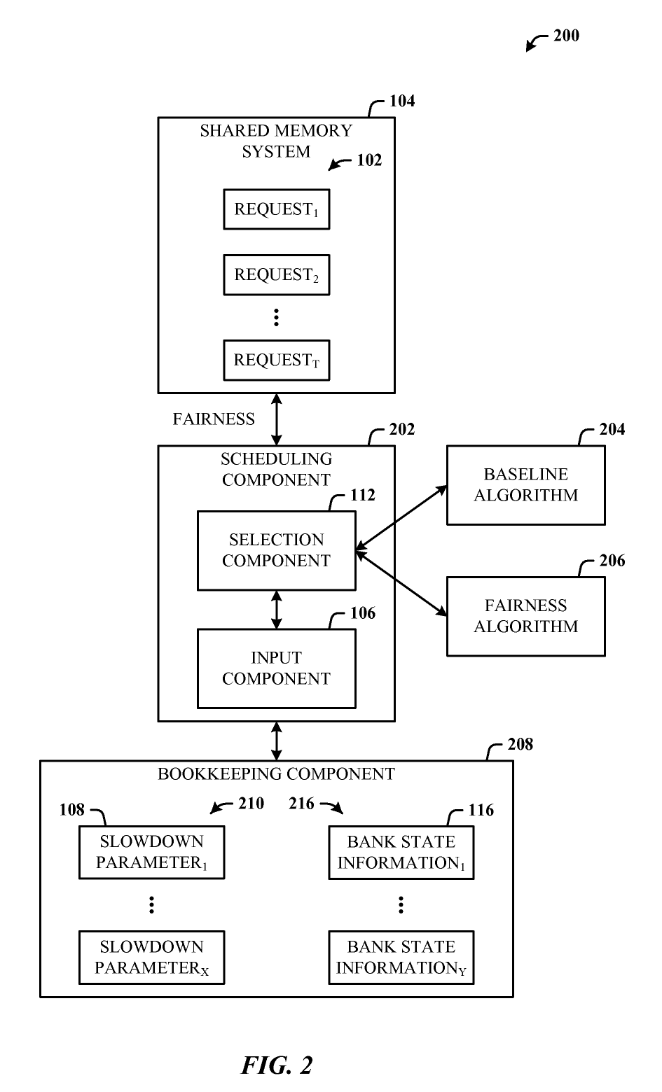

FIG. 2 illustrates an exemplary system 200 that employs fairness in the scheduling of memory access requests 102 in the shared memory system 104 (typically these requests may be stored in a memory request buffer (also referred to as a transaction buffer). Here, the input component 106 and selection component 112 are embodied as part of a scheduling component 202 (e.g., in a DRAM memory controller, or other volatile/non-volatile memory subsystems). The scheduling component 202 schedules request execution of threads based on selection (by the selection component 112) of a baseline scheduling algorithm 204 and/or a fairness scheduling algorithm 206. The baseline algorithm can be any suitable conventional scheduling algorithm such as First-Ready First-Come-First-Serve (FR-FCFS) or First-Come-First-Serve (FCFS), for example. The FR-FCFS algorithm is employed as the baseline algorithm in this description and is described in greater detail below.

When the system 200 determines that fairness is not being maintained, the scheduling component 112 then selects the fairness algorithm 206 for scheduling the requests 102, to bring the system back into a more optimized operation.

The system 200 also includes a bookkeeping component 208 that provides bookkeeping information (e.g., the slowdown parameter 108 and bank state information 116 to the scheduling component 202 such that the input component 106 and selection component 112 can operate to maintain fairness in the request scheduling. The bookkeeping component 208 continually operates to provide the needed information to the scheduler component 202. In order to maintain fairness, the following pieces of information are provided to the scheduling component 202 by the bookkeeping component 208: the bank information 116, which indicates the memory banks that are ready and which rows are currently open (e.g., in a row-buffer); and for each thread, the thread slowdown parameter 108 (also referred to herein as the thread slowdown index). The slowdown index is maintained for each thread and expresses how much the thread was slowed down in the multi-core execution process compared to an imaginary scenario in which the thread was running alone in the system. That is, the slowdown index of a thread i captures how much slowdown the thread has experienced due to contention in the memory system with other threads.

The bookkeeping component 208 generates and continually updates the slowdown parameters 210 (denoted SLOWDOWN PARAMETER₁, . . . ,SLOWDOWN PARAMETER_{X}, where X is a positive integer) for the corresponding requests 102. Additionally, bookkeeping component 208 generates and continually updates the bank state information 216 (denoted BANK STATE INFORMATION₁, . . . ,BANK STATE INFORMATION_{Y}, where Y is a positive integer) for the corresponding requests 102.

Following is a description of a fair memory scheduling model. As previously described, standard notions of fairness fail in providing fair request execution (and hence, performance isolation or security), when mapping requests onto shared memory systems. Fairness, as defined herein, is based on computing and maintaining two latencies for each thread. The first is the “real” latency, which is the latency that a thread experiences in the presence of other threads in the shared memory system (e.g., DRAM memory system in a multi-core system). The second is the “ideal” latency which is the inherent (depending on degree of memory access parallelism and row-buffer locality) latency that the thread would have had if it had run alone in the system (i.e., standalone, without any interference from other concurrently executed threads). For a thread, the ratio between the real latency and the ideal latency determines its performance slowdown. A fair memory system should schedule requests in such a way that the ratio between the real latency and the ideal latency is roughly the same for all threads in the system.

In a multi-core system with N threads, no thread should suffer more relative performance slowdown than any other thread (compared to the performance the thread gets if it used the same memory system by itself). Because each thread's slowdown is thus measured against its own baseline performance (single execution on the same system), the notion of fairness successfully dissects the two components of latency and takes into account the inherent characteristics of each thread.

In more technical terms, consider a slowdown index (or parameter) χᵢ for each currently executed thread i. In one implementation, the memory system only tracks threads that are currently issuing requests. The slowdown index captures the cost (in terms of relative additional latency) a thread i pays because the shared memory system is used by multiple threads in parallel in a multi-core architecture. In order to provide fairness across threads and contain the risk of DoS attacks, the memory controller should schedule outstanding requests in the buffer in such a way that the slowdown index χᵢ values are as balanced as possible. Such a scheduling ensures that each thread only suffers a fair amount of additional latency that is caused by the parallel usage of the shared memory system.

A formal definition of the slowdown index χᵢ is based on the notion of cumulated bank-latency L_{i,b}, defined as follows.

Definition 1. For each thread i and bank b, the cumulated bank-latency L_{i,b} is the number of memory cycles during which there exists an outstanding memory request by thread i for bank b in the memory request buffer. The cumulated latency of a thread Lᵢ=Σ_{b}L_{i,b} is the sum of all cumulated bank-latencies of thread i.

The motivation for this formulation of L_{i,b} is best seen when considering latencies on the level of individual memory requests. Consider a thread i and let R_{i,b}^{k} denote the kth memory request of thread i that accesses bank b. Each such request R_{i,b}^{k} is associated with three specific times: the request's arrival time a_{i,b}^{k} when the request is entered into the request buffer; the request's finish time f_{i,b}^{k}, when the request is completely serviced by the bank and sent to processor i's cache; and finally, the request's activation time

s_{i,b}^{k}:=max{f_{i,b}^{k-1}, a_{i,b}^{k}}.

The activation time is the earliest time when request R_{i,b}^{k} could be scheduled by the bank scheduler. It is the larger of the request's arrival time and the finish time of the previous request R_{i,b}^{k-1} that was issued by the same thread to the same bank. A request's activation time marks the point in time from which R_{i,b}^{k} is responsible for the ensuing latency of thread i; before s_{i,b}^{k}, the request was either not sent to the memory system or an earlier request to the same bank by the same thread was generating the latency.

With these definitions, the amortized latency λ_{i,b}^{k} of request R_{i,b}^{k} is the difference between the request's finish time and the request's activation time, that is, λ_{i,b}^{k}=f_{i,b}^{k}−s_{i,b}^{k}. By the definition of the activation times s_{i,b}^{k}, it is clear that at any point in time, the amortized latency of exactly one outstanding request is increasing (if there is at least one request in the request buffer). Hence, when describing time in terms of executed memory cycles, the definition of cumulated bank-latency L_{i,b} corresponds exactly to the sum over all amortized latencies to this bank, that is, L_{i,b}=Σₖλ_{i,b}^{k}.

In order to compute the experienced slowdown of each thread, the actual experienced cumulated latency Lᵢ of each thread i is compared to an imaginary, ideal single-core cumulated latency \tilde{L}ᵢ that serves as a baseline. This ideal latency \tilde{L}ᵢ is the minimal cumulated latency that thread i would have accrued if the thread had run as the only thread in the system using the same memory (e.g., DRAM). The ideal latency captures the latency component of Lᵢ that is inherent to the thread itself and not caused by contention with other threads. Hence, threads with good and bad row-buffer locality have small and large \tilde{L}ᵢ, respectively.

The slowdown index χᵢ that captures the relative slowdown of thread i caused by multi-core parallelism can now be defined as follows.

Definition 2. For a thread i, the memory slowdown index χᵢ is the ratio between the thread's cumulated latency Lᵢ and the thread's ideal single-core cumulated latency \tilde{L}ᵢ.

χᵢ:=Lᵢ/\tilde{L}ᵢ.

Note that alternative ways of defining the slowdown index are also possible. For example, the slowdown index can be defined as:

χᵢ:=Lᵢ−\tilde{L}ᵢ.

Notice that the above definitions do not take into account the service and waiting times of the shared memory bus and across-bank scheduling. Both the definition of fairness as well as the algorithm presented later in the description can be extended to take into account waiting times and other more subtle hardware issues. The disclosed model abstracts away numerous aspects of secondary importance because the definitions provide good approximations.

Finally, memory unfairness Ψ of a memory system is defined as the ratio between the maximum and minimum slowdown indexes χ over all currently executed threads in the system:

$$Ψ \text{:} = \frac{{max}_{i} {χ}_{i}}{{min}_{j} {χ}_{j}}$$

The “ideal” unfairness index Ψ=1 is achieved if all threads experience exactly the same slowdown; the higher Ψ, the more unbalanced is the experienced slowdown of different threads. A goal of a fair memory access scheduling algorithm is therefore to achieve an unfairness index Ψ that is as close to one as possible. This ensures that no thread is over-proportionally slowed down due to the shared nature of memory in multi-core systems. Notice that by taking into account the different row-buffer localities of different threads, the definition of unfairness prevents punishing threads for having either good or bad memory access behavior. Hence, a scheduling algorithm that achieves low memory unfairness mitigates the risk that any thread in the system, regardless of its bank and row access pattern, is unduly bogged down by other threads.

Note further that memory (e.g., DRAM, flash, etc.) unfairness is virtually unaffected by the idleness problem (i.e., bursty or temporarily idle threads that have been idle for some time and resume issuing memory requests that are prioritized over threads that continuously/steadily issue memory requests), because both cumulated latencies Lᵢ and ideal single-core cumulated latencies \tilde{L}ᵢ are only accrued when there are requests in the memory request buffer. Any scheme that tries to balance latencies between threads runs into the risk of what is referred to as the idleness problem. Threads that are temporarily idle (not issuing many memory requests, for instance due to an I/O operation) will be slowed down when returning to a more memory intensive access pattern.

On the other hand, in certain solutions based on network fair queuing, a memory hog could intentionally issue no or few memory requests for a period of time. During that time, other threads could “move ahead” at a proportionally lower latency, such that, when the malicious thread returns to an intensive access pattern, it is temporarily prioritized and normal threads are blocked. The idleness problem therefore poses a severe security and performance degradation risk. By exploiting idleness, an attacking memory hog could temporarily slow down or even block time-critical applications with high performance stability requirements from memory. Beyond the security risk, the idleness problem also causes a severe performance and fairness problem: every non-malicious application can potentially create this idleness problem if it exhibits a bursty memory-access behavior or is temporarily idle. Existing memory access schedulers often suffer from the idleness problem.

Short-Term vs. Long-Term Fairness: Thus far, the aspect of time-scale has remained unspecified in the definition of memory-unfairness. Both Lᵢ and \tilde{L}ᵢ continue to increase throughout the lifetime of a thread. Consequently, a short-term unfair treatment of a thread would have increasingly little impact on its slowdown index χᵢ. While still providing long-term fairness, threads that have been running for a long time could be treated unfairly and become vulnerable to short-term unfair treatment by the memory scheduling component or short-term DoS attacks even if the scheduling algorithm enforced an upper bound on memory unfairness Ψ. In this way, delay-sensitive applications could be blocked from memory for limited periods of time after having been executing for an extended period of time and the associated counters Lᵢ and \tilde{L}ᵢ are large.

Therefore, the definitions are generalized to include an additional parameter T that denotes the time-scale for which the definitions apply. In particular, Lᵢ(T) and \tilde{L}ᵢ(T) are the maximum (ideal single-core) cumulated latencies over all time-intervals of duration T during which thread i is active. Similarly, χᵢ(T) and Ψ(T) are defined as the maximum values over all time-intervals of length T. The parameter T in these definitions determines how short-term or long-term the considered fairness is. In particular, a memory scheduling algorithm with good long term fairness will have small Ψ(T) for large T, but possibly large Ψ(T′) for smaller T′. In view of the security issues raised, it is clear that a memory scheduling algorithm should aim at achieving small for both small Ψ(T) and large T.

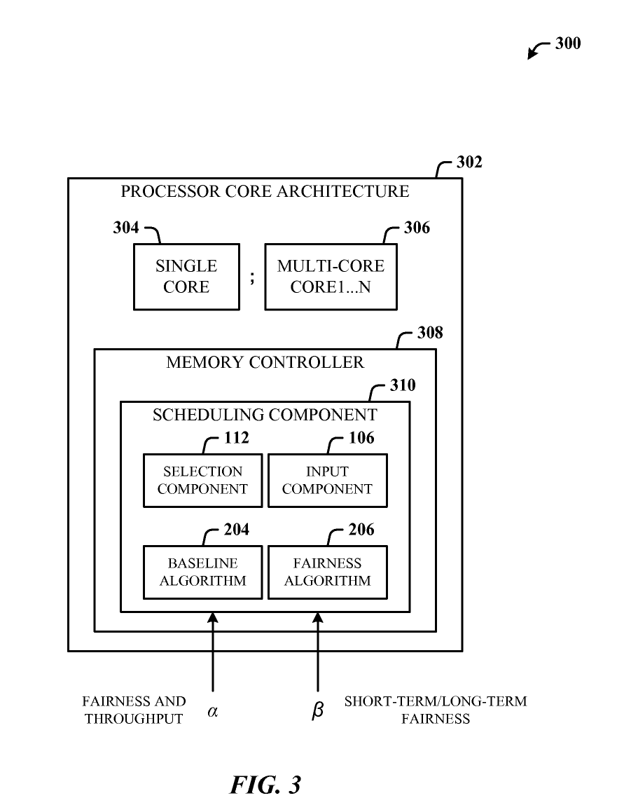

FIG. 3 illustrates a fair memory scheduling system 300 that includes the fairness algorithm 206 that achieves fairness according to the definitions above, and hence, balances the performance slowdown experienced by different applications/threads and also reduces the risk of performance slowdowns due to inter-thread interference and memory-related DoS attacks. The system 300 illustrates a processor core architecture 302 that can be a single core architecture 304 (for SMT or hyper-threading) or multi-core architecture 306. The process core 302 can include a memory controller 308 for managing memory access requests for multiple threads in accordance with the disclosed fairness architecture.

The reason why memory performance hogs (MPHs) can exist in multi-core systems is the unfairness in current memory access schedulers. Therefore, to mitigate such effects, the memory controller 308 includes a scheduling component 310 that here, includes not only the input component 106 and selection component 112, but also the baseline algorithm 204 and the fairness scheduling algorithm 206. The fairness algorithm 206 enforces fairness by balancing the relative memory-related slowdowns experienced by different threads. The fairness algorithm 206 schedules requests in such a way that each thread experiences a similar degree of memory-related slowdown relative to its performance when run alone.

In order to achieve this goal, the scheduling component 310 maintains the slowdown index χᵢ that characterizes the relative slowdown of each thread. As long as all threads have roughly the same slowdown, the scheduling component 310 schedules requests using the baseline algorithm (e.g., FR-FCFS) that typically attempts to optimize the throughput to the memory-system. When the slowdowns of different threads start diverging and the difference exceeds a certain threshold (when Ψ becomes too large), however, the scheduling component 310 switches to the alternative fairness algorithm 206 and begins prioritizing requests issued by threads experiencing large slowdowns.

The scheduling algorithm for memory controllers for multi-core systems, for example, is defined by means of two input parameters: α and β. These parameters can be used to fine-tune the involved trade-offs between fairness and throughput on the one hand (α) and short-term versus long-term fairness on the other (β). More specifically, α is a parameter that expresses to what extent the scheduling component 310 is allowed to optimize for memory throughput at the cost of fairness (how much memory unfairness is tolerable). The parameter β corresponds to the time-interval T that denotes the time-scale of the above fairness condition. In particular, the memory controller 308 divides time into windows of duration β, and for each thread, maintains an accurate account of the thread's accumulated latencies Lᵢ(β) and \tilde{L}ᵢ(β) in the current time window.

Note that in principle there are various possibilities of interpreting the term “current time window”. The simplest way is to completely reset Lᵢ(β) and \tilde{L}ᵢ(β) after each completion of a window. More sophisticated techniques can include maintaining multiple (e.g., say k) such windows of size β, in parallel, each shifted in time by β/k memory cycles. In this case, all windows are constantly updated, but only the oldest window is used for the purpose of decision-making. This helps in reducing volatility.

Following is a description of the request prioritization scheme employed by the FR-FCFS algorithm that can be used as the baseline algorithm 204 in this description. Current memory access schedulers are designed to maximize the bandwidth obtained from the memory. A simple request scheduling algorithm that serves requests based on a first-come-first-serve policy is prohibitive, because the algorithm incurs a large number of bank conflicts. Instead, current memory access schedulers usually employ the FR-FCFS algorithm to select which request should be scheduled next. The FR-FCFS algorithm prioritizes requests in the following order in a bank:

1. Row-hit-first: a bank scheduler gives higher priority to the requests that would be serviced faster. In other words, a request that would result in a row hit is prioritized over a request that would cause a row conflict.

2. Oldest-within-bank-first: a bank scheduler gives higher priority to the request that arrived earliest. Selection from the requests chosen by the bank schedulers is done as follows: oldest-across-banks-first—the across-bank bus scheduler selects the request with the earliest arrival time among all the requests selected by individual bank schedulers.

In summary, the FR-FCFS algorithm strives to maximize memory bandwidth by scheduling accesses that cause row hits first (regardless of when these requests have arrived) within a bank. Hence, streaming memory access patterns are prioritized within the memory system. The oldest row-hit request has the highest priority in the memory access scheduler. In contrast, the youngest row-conflict request has the lowest priority. (Note that although described in the context of FR-FCFS, it is to be understood that other conventional scheduling algorithms can be employed as the baseline algorithm.)

Instead of using the baseline algorithm 204 (e.g., FR-FCFS), the fairness algorithm 206 first determines two candidate requests from each bank b, one according to each of the following rules.

Highest FR-FCFS algorithm priority: Let R_{FR-FCFS} be the request to bank b that has the highest priority according to the following FR-FCFS scheduling policy. That is, row hits have higher priority than row conflicts, and-given this partial ordering—the oldest request is served first.

Highest fairness-index: Let i′ be the thread with highest current memory slowdown index χ_{i′}(β) that has at least one outstanding request in the memory request buffer to bank b. Among all requests to b issued by i′, let R_{Fair} be the request with highest FR-FCFS priority.

Between these two candidate requests, the fairness algorithm 206 chooses the request to be scheduled based on the following rule:

Fairness-oriented selection: Let χₗ(β) and χₛ(β) denote largest and smallest memory slowdown index of a thread that has at least one outstanding request in the memory request buffer for a current time window of duration β. If it holds that,

$$\frac{{χ}_{λ} ( β )}{{χ}_{s} ( β )} \geq α$$

then R_{Fair} is selected by bank b's scheduler and R_{FR-FCFS}, otherwise.

Instead of using the oldest-across-banks-first strategy as used in current memory schedulers, selection from requests chosen by the bank schedulers is handled as follows: highest-memory-fairness-index-first across banks—the request with highest slowdown index χᵢ(β) among all selected bank-requests is sent on the shared memory bus.

In principle, the fairness algorithm 206 is built to ensure that at no time memory unfairness Ψ(β) exceeds the parameter α. Whenever there is the risk of exceeding this threshold, the memory controller 308 will switch to a mode (the fairness algorithm 206) in which the controller 308 begins prioritizing threads with higher slowdown index values χᵢ, which mode decreases χᵢ. The mode also increases the lower slowdown index values χⱼ of threads that have had little slowdown so far. Consequently, this strategy balances large and small slowdowns, which decreases memory unfairness, balances the memory-related slowdown of threads (performance-fairness), and keeps potential memory-related DoS attacks in check.

Note that the fairness algorithm 206 always attempts to keep the necessary violations as small as possible. Another benefit is that an approximate version of the fairness algorithm 206 lends itself to efficient implementation in hardware. Additionally, the fairness algorithm 206 is robust with regard to the idleness problem mentioned previously. In particular, neither the real latency Lᵢ nor the ideal latency \tilde{L}ᵢ is increased or decreased if a thread has no outstanding memory requests in the request buffer. Hence, not issuing any requests for some period of time (either intentionally or unintentionally due to I/O, for instance) does not affect this thread's priority or any other thread's priority in the buffer.

Following is a description of exemplary hardware implementations of the algorithm 206. As described, the memory controller 308 always has full knowledge of every active (currently-executed) thread's real latency value Lᵢ and ideal latency value \tilde{L}ᵢ. Note that for describing the implementation of the fairness algorithm 206, it is assumed there is one thread per core. However, in systems where there are multiple threads per core, state should be maintained on a per-thread basis rather than on a per-core basis.

In an exact implementation, it is possible to ensure that the memory controller 308 always keeps accurate information of Lᵢ(β) and \tilde{L}ᵢ(β). Keeping track of Lᵢ(β) for each thread is simple. For each thread, two hardware counters are utilized that maintain the real latency Lᵢ and the ideal latency \tilde{L}ᵢ. The slowdown index χᵢ is then computed by dividing the two counter values real latency/ideal latency. The division can be performed using a hardware divider.

The real latency counter storing the real latency value Lᵢ is maintained and updated in such a way that it always contains an indicator of how much the memory-related latency of thread i is. The real latency counter is increased (updated) as follows. In each memory cycle, if thread i has at least one outstanding memory request (in the memory request buffer), the real latency counter is increased by the number of banks for which thread i has at least one outstanding request.

Consider the following example. Assume that thread i has three outstanding memory requests in the memory request buffer: one to Bank 1 and two to Bank 3. As long as these memory requests are in the memory request buffer, the real latency counter is increased by two in every memory cycle (one for each bank having at least one outstanding memory request). Assume that from these three requests, the first request to be completely served is the request to Bank 1. Until this request is completely served (the bank is ready for the next request), the real latency counter will be incremented by two in every memory cycle. Once this request is served, however, there remains only one bank with at least one outstanding memory request from thread i, and hence, the real latency counter is increased only by one in subsequent memory cycles.

The ideal latency counter for storing the ideal latency value \tilde{L}ᵢ is maintained as follows. Let L_{row-hit} be the number of memory cycles required for the bank to serve a request that goes to the row currently open in the row buffer. In other words, L_{row-hit} indicates how long (measured in memory cycles) the bank is in the “not-ready” state when a request is being served by that bank and the request goes to the row currently in this bank's row buffer. Similarly, L_{row-conflict} is the number of memory cycles required to serve a request when the request goes to a row other than the row currently stored in the bank's row buffer. In this case, the row currently in the row buffer first has to be written back to the bank, and the new row has to be loaded into the row buffer before the request can actually be served. This causes additional latency.

Finally, let L_{bus} be the number of memory cycles required to send a request to a bank (that is, L_{bus} describes how long the memory bus is busy). The exact values of L_{row-hit}, L_{row-conflict}, and L_{bus}, are hardware dependent. In conventional memory systems (e.g., DRAM), it holds that L_{row-conflict}>L_{row-hit} and L_{row-hit}>>L_{bus}.

The ideal counter containing the ideal latency value \tilde{L}ᵢ is updated whenever a request of thread i has been served completely. More specifically, whenever a request R issued by thread i is completely served (and the bank becomes ready again), \tilde{L}ᵢ is increased by L_{bus} plus either L_{row-conflict} or L_{row-hit}. The decision of whether \tilde{L}ᵢ is increased by L_{bus}+L_{row-conflict} or L_{bus}+L_{row-hit} after request R is served is based on whether request R would have caused a row-conflict or a row-hit if thread i had been the only thread running in the system. If thread i had been executed alone (without any of the other threads) and the request would have resulted in a row-hit (the row to which this request goes is already in the bank's row-buffer), then the ideal latency \tilde{L}ᵢ is increased by L_{bus}+L_{row-hit}. Otherwise, if the request would have resulted in a row-conflict (the request was to a row other than the one currently open in the row-buffer), then \tilde{L}ᵢ is increased by L_{bus}+L_{row-conflict}.

Consider the following example. Assume that thread i has three outstanding memory requests R1, R2, and R3 in the memory request buffer to the same bank. Assume further that the three requests were issued consecutively (there are no other requests to the same bank entering between requests R1, R2, and R3. Assume that R1 and R2 go to Row 1, whereas request R3 is to Row 2. If this thread is executed alone in the system, serving R2 will result in a row-hit (because Row 1 is already loaded into the row-buffer after R1 is served). However, R3 will create a row-conflict, because request R3 is for Row 2, whereas the row-buffer contains Row 1 after R2 is served. Therefore, when request R2 is served in the multi-core processor memory system, the disclosed fair memory system design will update the ideal latency as \tilde{L}ᵢ=\tilde{L}ᵢ+L_{bus}+L_{row-hit}, regardless of whether request R2 actually resulted in a row-hit or a row-conflict in the real execution. On the other hand, when R3 is served, the ideal latency will be updated as \tilde{L}ᵢ=\tilde{L}ᵢ+L_{bus}+L_{row-conflict}, regardless of R3 was actually a row-hit or a row-conflict.

The memory request scheduler knows whether a request would have been a row-hit or a row-conflict in the idealized case (in which thread i is running alone) based on a set of counters that are maintained and reflect the state of the row-buffer in the idealized scenario. In addition to the real latency counter Lᵢ and the ideal latency counter \tilde{L}ᵢ per thread, the disclosed fair memory system also maintains hardware registers for each bank and for each core (resulting in a total number of counters of two times the number of cores plus+number of cores times the number of banks). Each of these registers C_{i,b} maintains the row-number in Bank b that the memory system would have open if thread i had been the only thread in the system. Collectively, these registers C_{i,b} thus maintain a complete “ideal” state of the memory system (which row would currently have been in the row-buffer of each bank) for each thread (core).

These registers C_{i,b} can be maintained in the following way. Each time a request to Bank b and Row r issued by thread i has been completely served by the memory system, the register C_{i,b} is updated as follows: C_{i,b}:=r. That is, register C_{i,b} maintains the row-number that would currently have been in the row-buffer if there were no other threads running in the system besides thread i.

Assume that a request by the thread in Core 1 to Bank b and Row r has been served. Then, the ideal latency counter of thread 1 (\tilde{L}₁) and the row-number C_{1,b} are updated as follows.

If C_{1,b}=r, then \tilde{L}₁:=\tilde{L}₁+L_{bus}+L_{row-hit}; 1)

else \tilde{L}₁:=\tilde{L}₁+L_{bus}+L_{row-conflict};

C_{1,b}:=r. 2)

First, the ideal latencies are updated according to the rules explained in the second example above, and then, the state register C_{1,b} (in general, C_{i,b}) is correctly updated to reflect the new state of the bank in the idealized setting.

In more technical terms, for each active thread, a counter maintains the number of memory cycles during which at least one request of this thread is buffered for each bank. After completion of the window β (or when a new thread is scheduled on a core), the counters are reset. The more difficult part of maintaining an accurate account of \tilde{L}ᵢ(β) can be done as follows: At all times, maintain for each active thread i and for each bank, the row that would currently be in the row-buffer if i had been the only thread using the DRAM memory system. This can be done for instance by simulating the baseline algorithm (e.g., FR-FCFS) priority scheme for each thread and bank that ignores all requests issued by threads other than i.

The \tilde{λ}_{i,b}^{k} latency of each request R_{i,b}^{k} then corresponds to the latency this request would have caused if DRAM memory was not shared. Whenever a request is served, the memory controller can add this “ideal latency” to the corresponding \tilde{L}_{i,b}(β) of that thread and-if necessary-update the simulated state register of the row-buffer accordingly. For instance, assume that a request R_{i,b}^{k} is served, but results in a row conflict. Assume further that the same request would have been a row hit, that is, if thread i had run by itself, request R_{i,b}^{k-1} accesses the same row as R_{i,b}^{k}. In this case, \tilde{L}_{i,b}(β) is increased by row-hit latency Tₕᵢₜ, whereas L_{i,b}(β) is increased by the bank-conflict latency T_{conf}. By “simulating” its own execution for each thread, the memory controller 308 obtains accurate information for all \tilde{L}_{i,b}(β).

Although a possible implementation, the above implementation is expensive in terms of hardware overhead and cost, and requires maintaining at least one counter for each core x bank pair. Similarly costly, the implementation requires one divider per core in order to compute the value Xᵢ(β)=Lᵢ(β)/\tilde{L}ᵢ(β) for the thread that is currently running on that core in every memory cycle. Less costly hardware implementations are possible because the memory controller 308 does not need to know the exact values of L_{i,b} and \tilde{L}i,b at any given moment. Instead, using reasonably accurate approximate values suffices to maintain an excellent level of fairness and security.

One exemplary embodiment reduces the number of counters by sampling. Using sampling techniques, the number of counters that would normally be maintained in the prior implementation can be reduced from O(#Banks×#Cores) to O(#Cores), where # means “number of”, with only minimal loss in accuracy. In other words, for each core and its active thread, two counters Sᵢ and Hᵢ are maintained denoting the number of samples and sampled hits, respectively. Instead of keeping track of the exact row that would be open in the row-buffer if a thread i was running alone, a subset of requests R_{i,b}^{k} issued by thread i is randomly sampled and checked whether the next request by thread i to the same bank, R_{i,b}^{k+1} is for the same row. If so, the memory controller 308 increases both counters Sᵢ and Hᵢ, otherwise, only Sᵢ is increased.

Requests R_{i,b}^{q} to different banks b′=b served between requests R_{i,b}^{k} and R_{i,b}^{k+1} are ignored. Finally, if none of the Q requests of thread i following R_{i,b}^{k} go to bank b, the sample is discarded, neither Sᵢ nor Hᵢ is increased, and a new sample request is taken. With this technique, the probability Hᵢ/Sᵢ that a request results in a row hit gives the memory controller 308 a reasonably accurate picture of each thread's row-buffer locality. An approximation of \tilde{L}ᵢ can thus be maintained by adding the expected amortized latency to the approximation whenever a request is served. In other terms,

\tilde{L}ᵢ^{new}:=\tilde{L}ᵢ^{old}+(Hᵢ/Sᵢ·Tₕᵢₜ+(1−Hᵢ/Sᵢ·T_{conf}).

The ideal scheme employs O(#Cores) hardware dividers, which significantly increases the memory controller's energy consumption. Instead, a single divider can be used for all cores by assigning individual threads to it in a round robin fashion. That is, while the slowdowns Lᵢ(β) and \tilde{L}ᵢ(β) can be updated in every memory cycle, the quotient χᵢ(β) is recomputed in intervals.

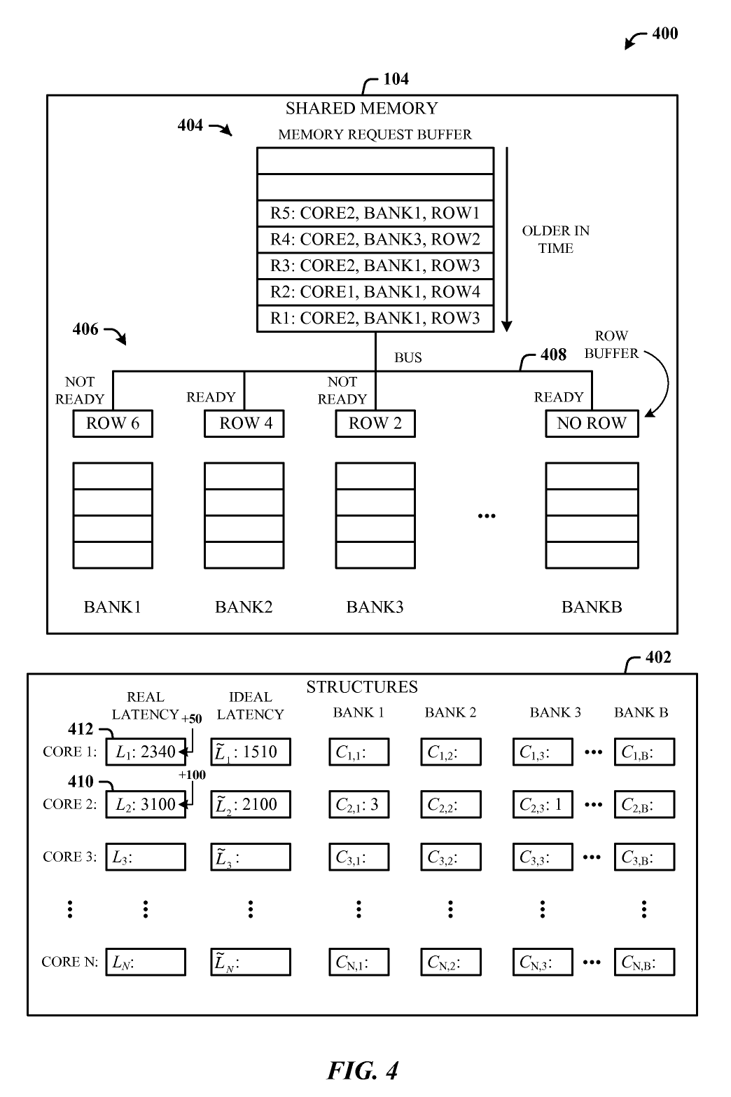

The following figures represent exemplary activities that occur in fair memory structures when using the disclosed fairness algorithm and associated update processes. FIG. 4 illustrates state in a system 400 that includes the shared memory 104 and structures 402 for maintaining counts and state associated with fairness processing. The shared memory 104 includes a request buffer 404 with outstanding requests scheduled for processing against memory banks and rows 406. The shared memory 104 also is represented as having a memory bus 408 in various states (READY, NOT READY) for rows in each bank. Because Bank1 and Bank3 are in a not-ready state, no request in the request buffer 404 can currently be served. In each memory cycle, the real latency count L₂ in a real latency counter 410 for Core2 is increased by 2, because there is at least one outstanding request by the thread executing on Core2 for Bank 1 and for Bank 3. In each memory cycle, the real latency count L₁ in a real latency counter 414 for Core1 is increased by 1, because there is one outstanding request for Bank1 by the thread executed on Core1. Assume that Bank1 becomes ready fifty memory cycles subsequent. The new real latency counts will be increased by 50 counts and 100 counts, results in counter values of L₁=2390 and L₂=3200, respectively. When Bank1 becomes ready, request R1 is the next to be served.

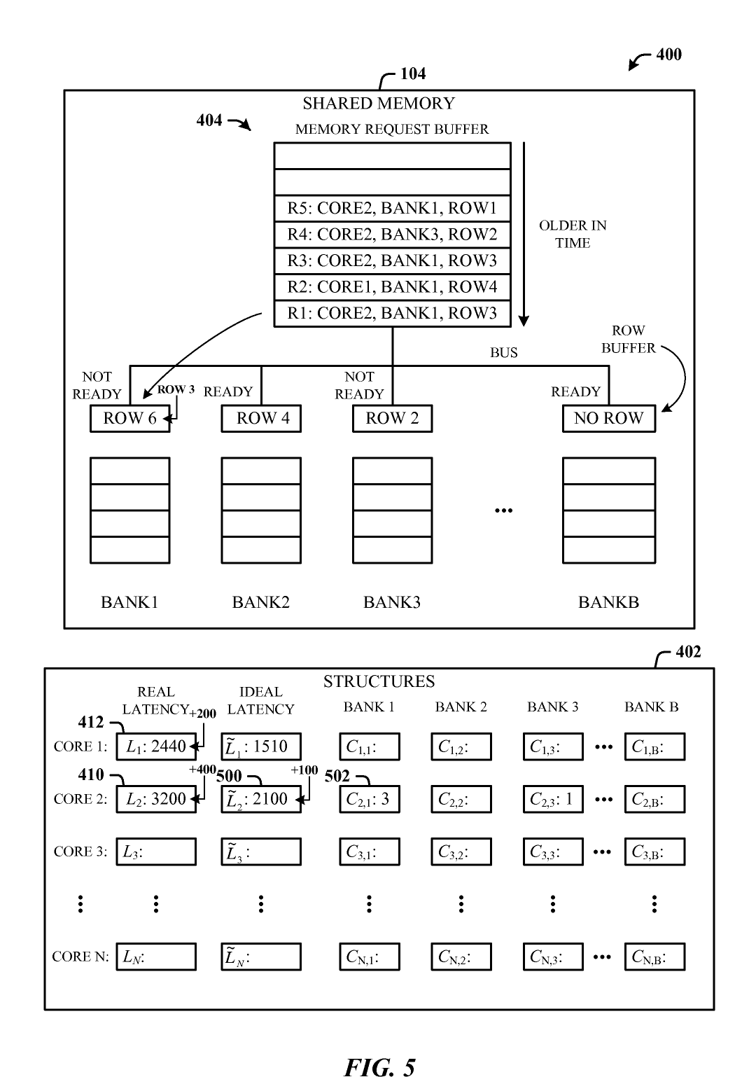

FIG. 5 illustrates state in the system 400 that can occur when a memory bank in the shared memory 104 becomes ready and a request in the request buffer 404 is next to be served. When Bank1 becomes ready and request R1 in the request buffer 404 is the next to be served, the access results in a row-conflict because the request is for Row3, whereas the row currently open in the row-buffer of Bank1 is Row6. A counter 502 (designated C_{2,1}) has the value of three. This means that Row3 would have been open in the row-buffer if no other thread other than the thread on Core2 had been running. Hence, request R1 would have been a row-hit in this ideal scenario.

Assume that L_{bus}+L_{row-hit}=100 memory cycles, and that L_{bus}+L_{row-conflict}=200 cycles. When request R1 is completely served (L_{bus}+L_{row-conflict}=200 memory cycles later), the ideal latency count \tilde{L}₂ in ideal latency counter 500 is increased by L_{bus}+L_{row-hit}=100 cycles. The counter 502 does not need to be changed, because the row counter 502 already stores a value of three, which is the row request R1 accessed. While request R1 is being served, the real latencies L₁ and L₂ in corresponding counters 412 and 410 continue being increased by values of one and two, respectively, for each memory cycle. Hence, when request R1 is completely serviced after 200 cycles, counts for the real latencies L₁ and L₂ will have been increased by 200 and 400, respectively, resulting in L₁=2440 and L₂=3200.

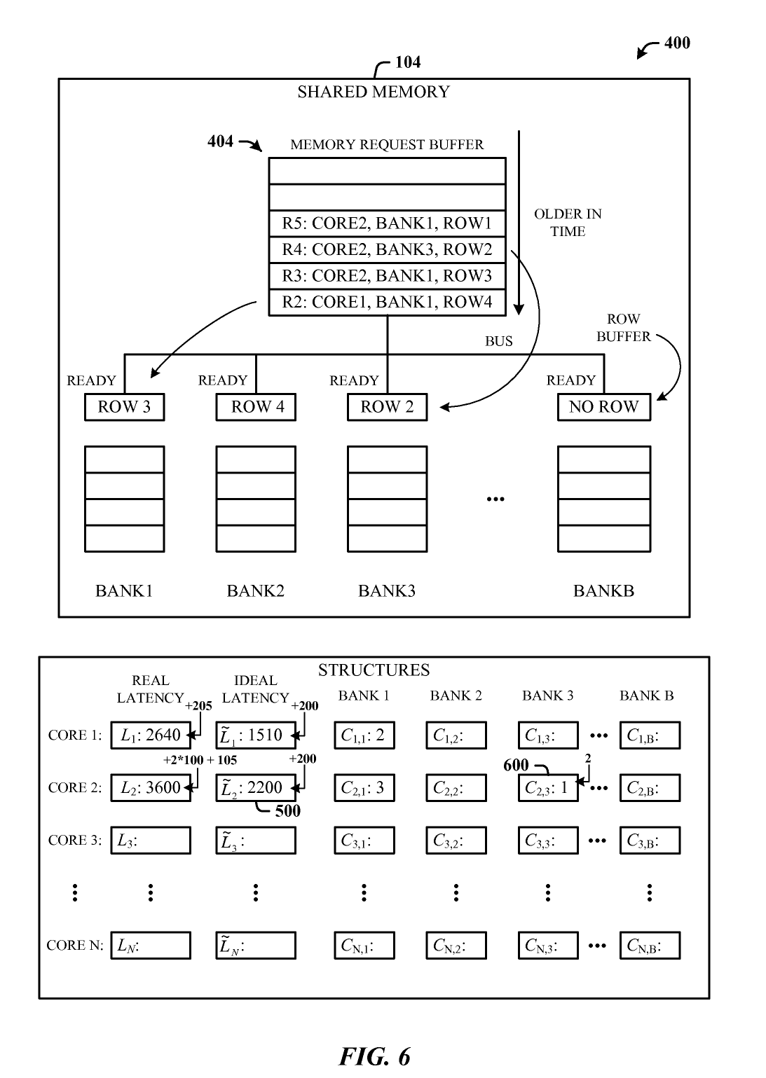

FIG. 6 illustrates state in the system 400 that can occur when serving a next request. The next request to be served in the request buffer 404 is request R4 to Bank3 and Row2. Five memory cycles later, request R2 is served by Bank1. Bank3 currently stores Row2 in the row-buffer such that request R4 results in a row-hit. However, the value stored in counter 600 (designated C_{2,3}) is one. That is, if thread 2 had been running alone, request R4 would have caused a row-conflict. (This means that some other thread must have loaded Row2). The time to serve request R4 is 100 cycles, but the ideal latency \tilde{L}₂ is increased by L_{bus}+L_{row-conflict}=200 cycles. Additionally, as soon as request R4 is finished being served, counter 600 (or C_{2,3}) is updated: C_{2,3}:=2. In the meantime, request R2 results in a row-conflict at Bank1 and the idealized case would have resulted in a row-conflict as well (because C_{1,1} is 2, but the requested row of request R2 is 4). Serving request R2 requires 200 cycles. The real and ideal latencies are updated appropriately. Note that after request R4 has been served (after 100 cycles), the real latency of Core2 increases only by one in each of the remaining 105 cycles.

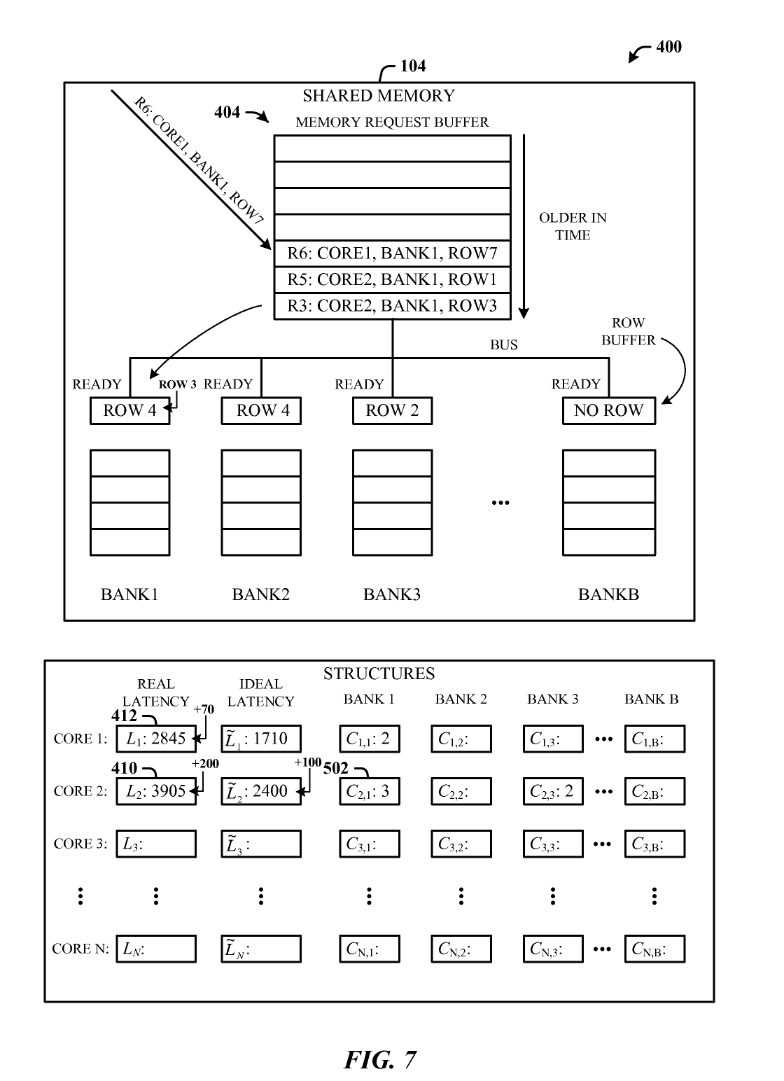

FIG. 7 illustrates state in the system 400 that can occur when serving a next request. As Bank1 is ready, the next request to be scheduled is R3. Request R3 is to Bank1 and Row3, which creates a row-conflict. However, since counter C_{2,1}=3, this means that there would have been a row-hit in the idealized scenario. Hence, after request R3 is served, the ideal latency \tilde{L}₂ increases by 100. Since the actual access is a row-conflict, it takes 200 cycles to serve request R3, and the real latency count L₂ grows accordingly during that period. At the end of the servicing of request R3, the real latency counter 410 will be increased by 200. The row counter 502 (or C_{2,1}) is not updated (since the row number is already 3). Assume that 130 cycles after request R3 was scheduled, a new request R6 is inserted to the memory request buffer 404. From that time on, the real latency count L₁ in counter 412 resumes increasing on every cycle until request R6 is fully serviced by the memory system. FIG. 7 shows the increase in real latency L₁ when request R3 is serviced (request R3 takes 200 cycles to be serviced and request R6 arrived 130 cycles after request R3 was scheduled, so Core1 incurs a real latency of 70 cycles at counter 412.

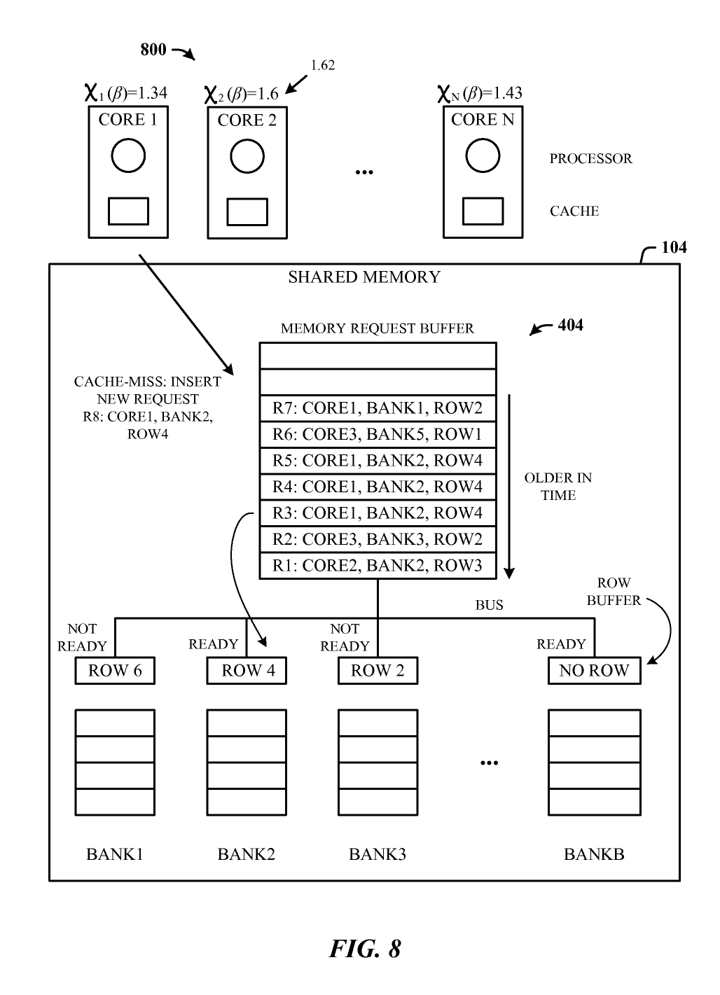

FIG. 8 illustrates fairness scheduling based on unfairness exceeding a predetermined threshold. Assume the unfairness threshold α=1.2. When selecting the next request in the request buffer 404 to be served by Bank2, the fairness scheduling algorithm first determines whether χₗ(β)/χₛ(β)≧α. In this case, assume that the thread on Core2 has the highest slowdown index and the thread on Core1 has the lowest. Therefore, it holds that χₗ(β)/χₛ(β)=1.6/1.34=1.194<α. Therefore, according to the algorithm, the baseline algorithm (e.g., FR-FCFS) rule is applied and request R3 is scheduled to Bank2 first because it creates a row-hit. Bank2 then becomes “not-ready”. Bank2 becomes ready again when request R3 is served (this time depends on the hardware latency). Because the thread executed in Core2 was not considered (but it would have been if this thread had been the only thread running in the system), the χ₂(β) value of this thread at core 800 (denoted Core2) is updated (e.g., increased from 1.6 to 1.62). Once the respective requests are scheduled, Bank1 and Bank3 become ready. When a processor issues a new memory request, it is inserted into the memory request buffer (R8).

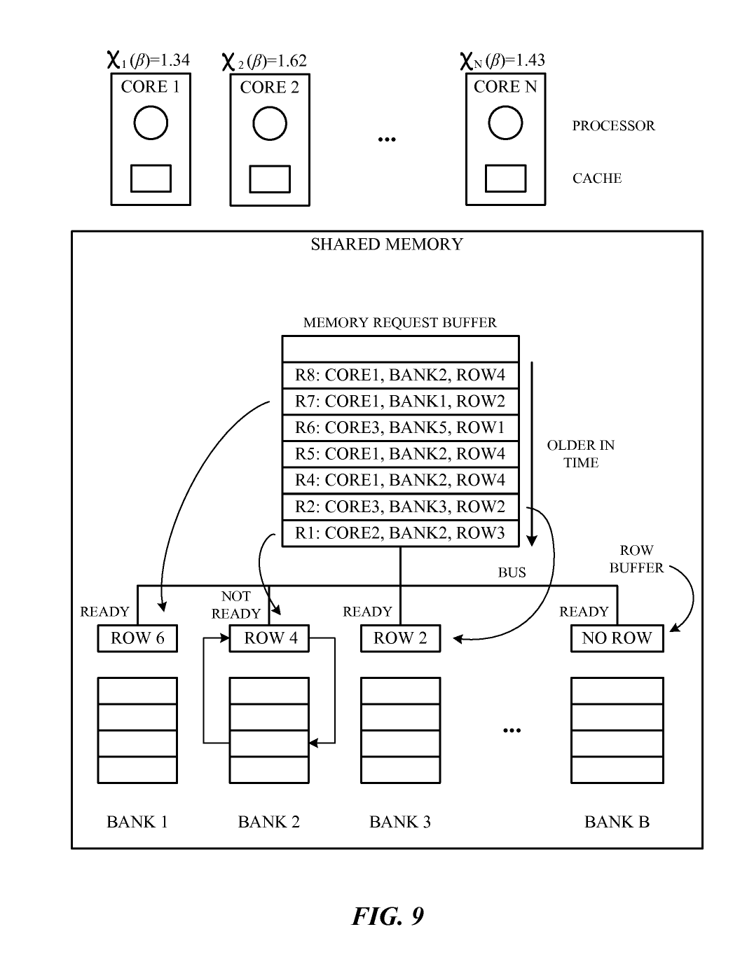

FIG. 9 illustrates fairness scheduling of FIG. 8 when serving a next request. The next request to be served is R2 (according to baseline algorithm FR-FCFS) because Bank3 is ready R2 results in a row-hit. Hence, request R2 is selected by Bank3's scheduler. Although request R7 is selected by Bank1's scheduler, request R2 is scheduled because request R2 is older than request R7. Request R7 is subsequently served (as in the baseline algorithm) because Bank1 is ready and request R7 is selected by Bank1's scheduler. No other banks can select any request. Bank2 then becomes ready. Because the thread executed in Core2 was not served initially, its slowdown index χ₂(β) has increased to 1.62. When Bank2 becomes ready, the fairness scheduling algorithm again determines whether χₗ(β)/χₛ(β)≧α. Again assuming that Core2 has the highest slowdown index and Core1 has the lowest, it holds that χₗ(β)/χₛ(β)=1.62/1.34=1.21>α. Therefore, according to the fairness algorithm, the fairness rule is applied, and since the thread on Core2 has the highest slowdown index, only requests from this thread are considered for scheduling. In this example, this means that request R1 is scheduled to Bank2 even though it results in a row-conflict, whereas the request R4 from the thread on Core1 would be a row-hit. Hence, in this case, the fairness algorithm selects a memory request other than the request the FR-FCFS baseline algorithm would have selected. Once request R1 is served, the slowdown indexes will be adjusted again and χ₂(β) will decrease.

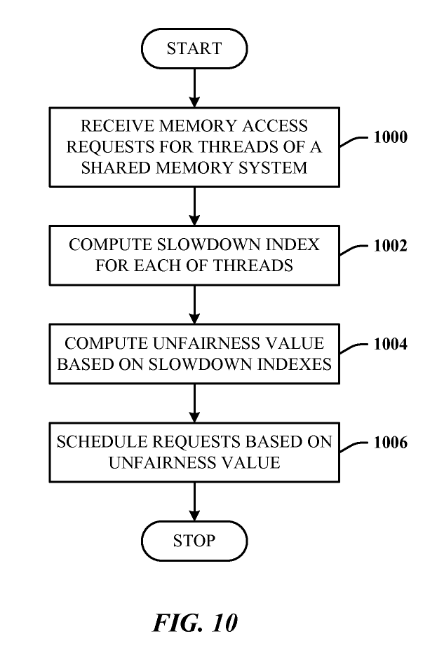

FIG. 10 illustrates a method of applying fairness in memory access requests. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 1000, memory access requests are received for threads of a shared memory system. At 1002, a slowdown index is computed for each of the threads. At 1004, an unfairness value is computed based on the slowdown indexes. At 1006, the requests are scheduled based on the unfairness value.

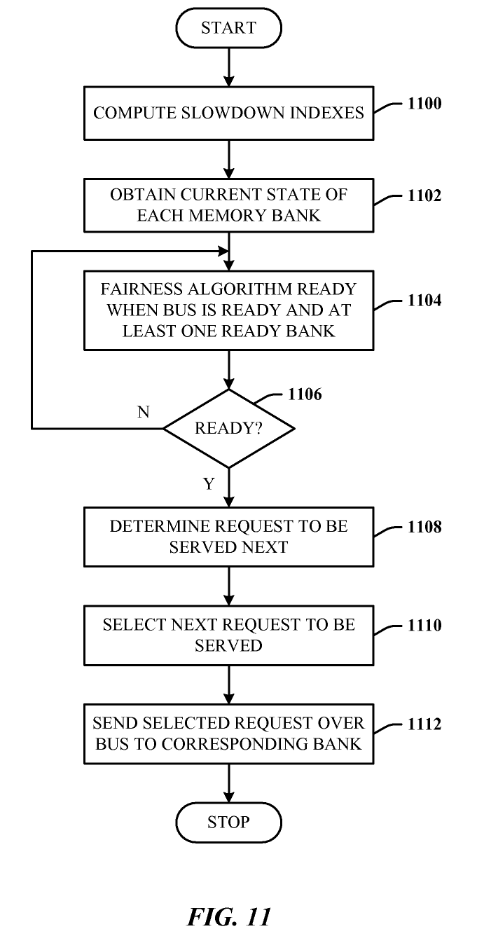

FIG. 11 illustrates a method of enabling a fairness algorithm based on memory bus and bank state. The memory request scheduling algorithm is invoked whenever the bus is ready (no other request is currently sent to a bank) and there is at least one ready bank (not currently serving another request). If these conditions hold, the memory request algorithm determines the next request to be served next. This selected request is then sent over the bus to the respective bank. At 1100, the slowdown indexes are computed. At 1102, current state of each memory bank is obtained. At 1104, the fairness algorithm is enabled based on a check of when the memory bus is ready and at least one memory bank is ready. At 1106, if the checks are not ready, flow is back to 1104 to continue monitoring the state. If the checks are ready, flow is from 1106 to 1108 to determine the request to be served next. At 1110, the next request to be served is selected. At 1112, the selected request is sent over the bus to the corresponding bank.

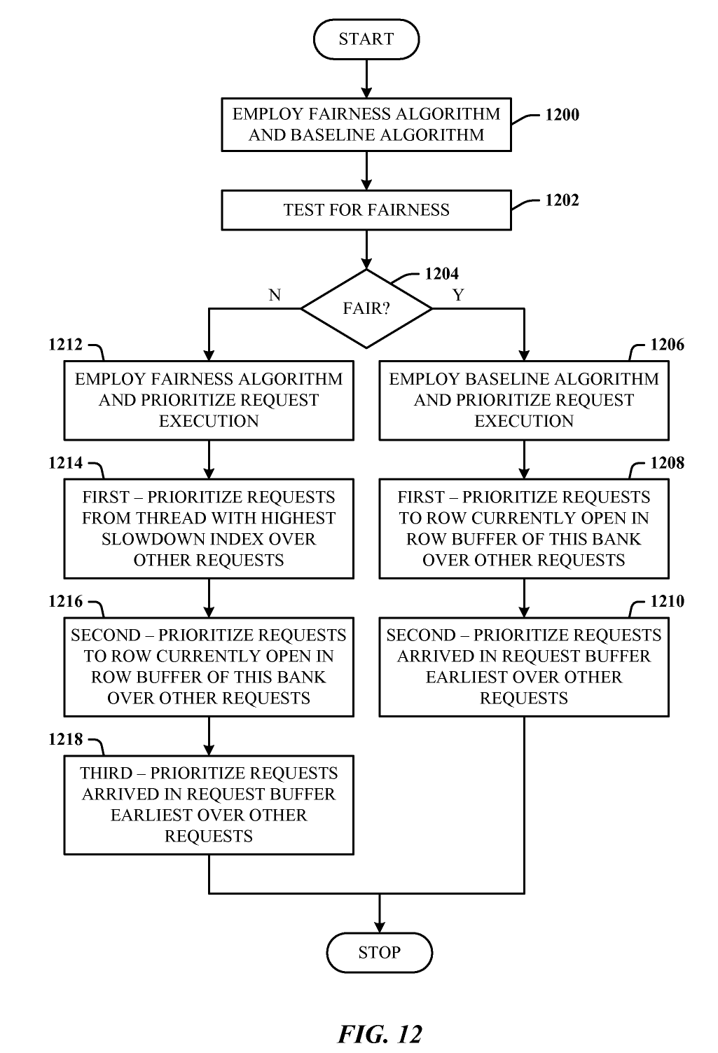

FIG. 12 illustrates a generalized method of scheduling memory requests based on a baseline algorithm and a fairness algorithm. At 1200, the fairness and baseline algorithm are employed. At 1202, the algorithm tests for fairness. At 1204, if the system is operating in a fair state, flow is to 1206 where the baseline algorithm is employed and request execution prioritized according to the baseline algorithm. At 1208, according to a baseline algorithm, first, requests to a row currently open in the row buffer of the current bank are prioritized over other requests. At 1210, requests that arrived the earliest in the request buffer are prioritized over other requests. If, at 1204, request processing is determined to be unfair, flow is from 1204 to 1212 to employ the fairness algorithm and prioritize request execution accordingly. At 1214, requests from the thread with the highest slowdown index are prioritized over other requests. At 1216, requests to the row that is currently open in the row buffer of the current bank are prioritized over other requests. At 1218, next, requests that arrived earliest in the request buffer are prioritized over other requests.

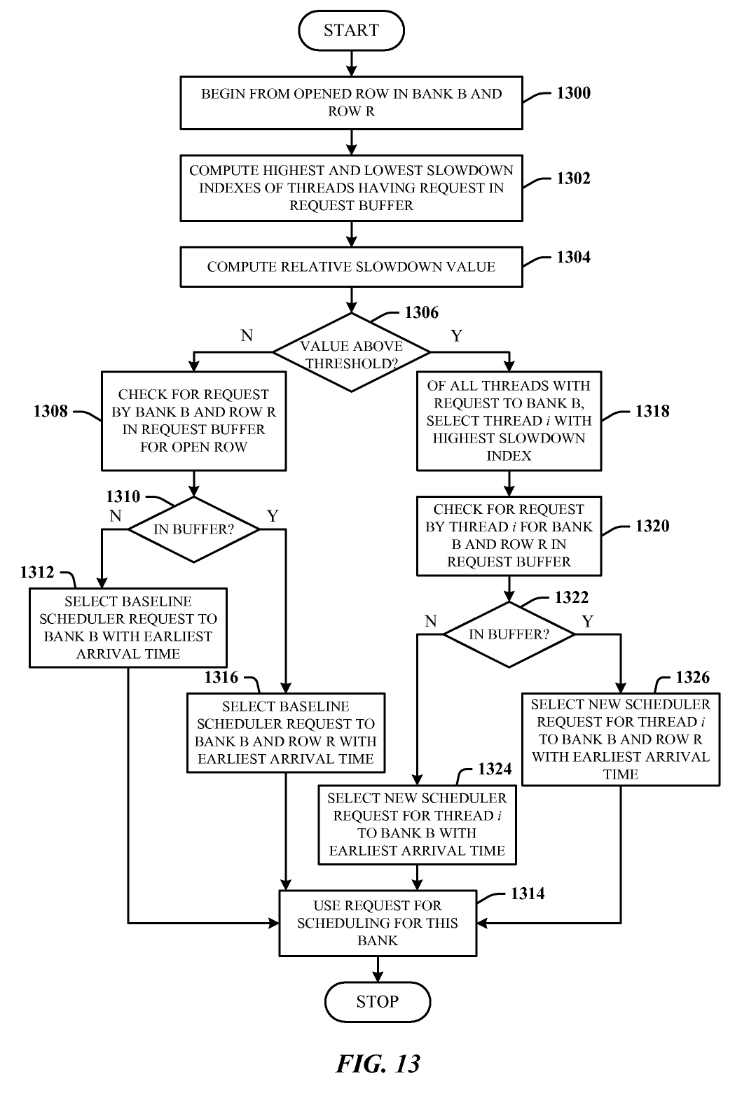

FIG. 13 illustrates a more detailed method of employing fairness in memory access processing. At 1300, the description begins based on an open Bank B and Row R. At 1302, the highest and lowest slowdown indexes of threads having requests in the request buffer. At 1304, the relative slowdown value is computed. At 1306, the algorithm checks if the value is above a predetermined threshold. If not, flow is to 1308 to then check for a request by Bank B and Row R in the request buffer for an open row. At 1310, if such a request is not in the buffer, flow is to 1312 to then select the baseline algorithm scheduler request to Bank B with the earliest arrival time (or oldest request). At 1314, the request is used for scheduling this bank (Bank B). If such a request is in the request buffer, flow is from 1310 to 1316 to select the baseline algorithm scheduler request to Bank B and Row R with earliest arrival time (or oldest request in the buffer). Flow is then to 1314 to use the request for scheduling this bank.

At 1306, if the slowdown value is above the threshold, flow is to 1318 where of all the threads with a request to Bank B, the thread i with the highest slowdown index is selected. At 1320, a check is made of thread i for a request for Bank B and Row R in the request buffer. At 1322, if such a request is not in the buffer, flow is to 1324 to select a new scheduler request for thread i to Bank B with the earliest arrival time. Flow is then to 1314 to use the request for scheduling for the Bank B. If, however, the request is in the buffer, flow is from 1322 to 1326 to select a new scheduler request for thread i to Bank B and Row R with the earliest arrival time. Flow is then to 1314.

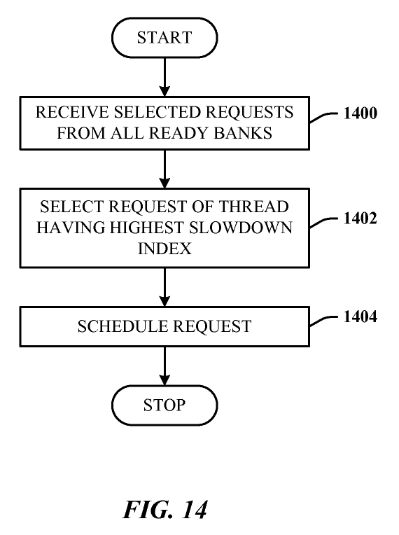

FIG. 14 illustrates a method of selecting the next request from across banks (an across-bank scheduler). At 1400, selected requests from all ready banks are received. At 1402, a request of the thread having the highest index is selected. At 1404, the request is then scheduled.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

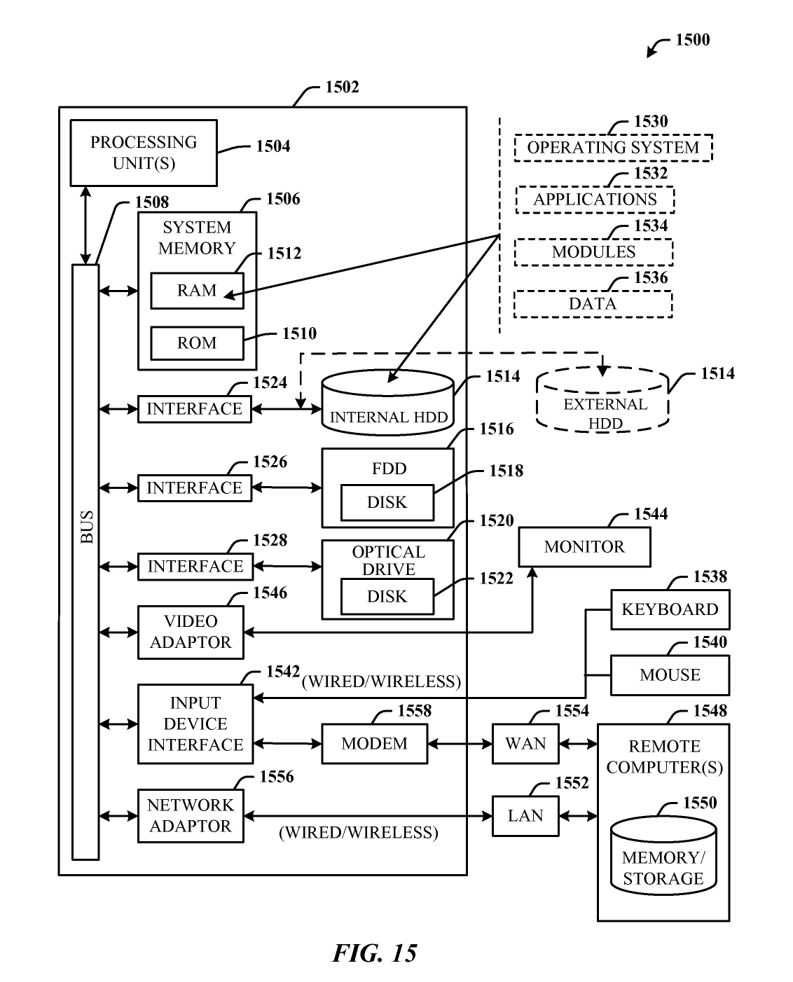

Referring now to FIG. 15, there is illustrated a block diagram of a computing system 1500 operable to execute the disclosed fairness algorithm architecture. In order to provide additional context for various aspects thereof, FIG. 15 and the following discussion are intended to provide a brief, general description of a suitable computing system 1500 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 15, the exemplary computing system 1500 for implementing various aspects includes a computer 1502, the computer 1502 including a processing unit(s) 1504, a system memory 1506 and a system bus 1508. The system bus 1508 provides an interface for system components including, but not limited to, the system memory 1506 to the processing unit 1504. The processing unit 1504 can be any of various commercially available processors. Dual microprocessors and other multi-processor architectures may also be employed as the processing unit 1504.

The system bus 1508 can be any of several types of bus structure that may further interconnect to a memory bus (with or without a memory controller), a peripheral bus, and a local bus using any of a variety of commercially available bus architectures. The system memory 1506 includes read-only memory (ROM) 1510 and random access memory (RAM) 1512. A basic input/output system (BIOS) is stored in a non-volatile memory 1510 such as ROM, EPROM, EEPROM, which BIOS contains the basic routines that help to transfer information between elements within the computer 1502, such as during start-up. The RAM 1512 can also include a high-speed RAM such as static RAM for caching data.

The computer 1502 further includes an internal hard disk drive (HDD) 1514 (e.g., EIDE, SATA), which internal hard disk drive 1514 may also be configured for external use in a suitable chassis (not shown), a magnetic floppy disk drive (FDD) 1516, (e.g., to read from or write to a removable diskette 1518) and an optical disk drive 1520, (e.g., reading a CD-ROM disk 1522 or, to read from or write to other high capacity optical media such as the DVD). The hard disk drive 1514, magnetic disk drive 1516 and optical disk drive 1520 can be connected to the system bus 1508 by a hard disk drive interface 1524, a magnetic disk drive interface 1526 and an optical drive interface 1528, respectively. The interface 1524 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1502, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 1512, including an operating system 1530, one or more application programs 1532, other program modules 1534 and program data 1536. The operating system 1530, one or more application programs 1532, other program modules 1534 and/or program data 1536 can include the input component 106, selection component 112, slowdown parameter 108, bank state information 116, bookkeeping component 208, scheduling component 202, baseline algorithm 204, and fairness algorithm 206, for example. The processing unit(s) 1504 can include the onboard cache memory via which the fairness architecture operates to provide fairness to the threads of the applications 1532, for example.

All or portions of the operating system, applications, modules, and/or data can also be cached in the RAM 1512. It is to be appreciated that the disclosed architecture can be implemented with various commercially available operating systems or combinations of operating systems. The disclosed architecture is typically implemented in hardware at the memory controller.

A user can enter commands and information into the computer 1502 through one or more wire/wireless input devices, for example, a keyboard 1538 and a pointing device, such as a mouse 1540. Other input devices (not shown) may include a microphone, an IR remote control, a joystick, a game pad, a stylus pen, touch screen, or the like. These and other input devices are often connected to the processing unit(s) 1504 through an input device interface 1542 that is coupled to the system bus 1508, but can be connected by other interfaces, such as a parallel port, an IEEE 1394 serial port, a game port, a USB port, an IR interface, etc.

A monitor 1544 or other type of display device is also connected to the system bus 1508 via an interface, such as a video adapter 1546. In addition to the monitor 1544, a computer typically includes other peripheral output devices (not shown), such as speakers, printers, etc.

The computer 1502 may operate in a networked environment using logical connections via wire and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wire/wireless connectivity to a local area network (LAN) 1552 and/or larger networks, for example, a wide area network (WAN) 1554. Such LAN and WAN networking environments are commonplace in offices and companies, and facilitate enterprise-wide computer networks, such as intranets, all of which may connect to a global communications network, for example, the Internet.

When used in a LAN networking environment, the computer 1502 is connected to the local network 1552 through a wire and/or wireless communication network interface or adapter 1556. The adaptor 1556 may facilitate wire or wireless communication to the LAN 1552, which may also include a wireless access point disposed thereon for communicating with the wireless adaptor 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wire and/or wireless device, is connected to the system bus 1508 via the serial port interface 1542. In a networked environment, program modules depicted relative to the computer 1502, or portions thereof, can be stored in the remote memory/storage device 1550. It will be appreciated that the network connections shown are exemplary and other means of establishing a communications link between the computers can be used.

The computer 1502 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented memory management system, comprising:
a component for receiving thread-based unfairness parameters associated with performance slowdown of corresponding threads, the performance slowdown related to processing of memory access requests in a shared memory system; and
a selection component for applying fairness to scheduling of a memory access request relative to other requests based on the unfairness parameters.

2. The system of claim 1, wherein an unfairness parameter is a function of memory-related performance slowdown of a thread, the function defined by a real latency value and an ideal latency value, both derived from memory latency experienced by the thread.

3. The system of claim 1, wherein the selection component selects between a baseline scheduling algorithm and a fairness scheduling algorithm based on a slowdown index computed for each request.

4. The system of claim 1, wherein the selection component includes a predetermined threshold value against which an unfairness parameter is compared to determine whether to apply the fairness.

5. The system of claim 1, wherein the component receives a first parameter associated with a measure of unfairness and throughput, and a second parameter associated with a time interval that denotes a time-scale for the fairness.

6. The system of claim 1, wherein the unfairness parameter is based on a highest slowdown index and a lowest slowdown index.

7. The system of claim 1, further comprising a bookkeeping component for computing an unfairness parameter based on slowdown indexes for all requests to be scheduled.

8. The system of claim 1, wherein the fairness applied by the selection component balances the fairness with throughput.

9. The system of claim 1, wherein the shared memory system is part of a multi-core architecture.

10. A computer-implemented method of managing memory, comprising:
receiving memory access requests of threads in a shared memory system;
computing slowdown indexes for the threads;
computing an unfairness value based on the slowdown indexes; and
scheduling the requests based on the unfairness value.

11. The method of claim 10, further comprising minimizing the slowdown indexes to optimize throughput.

12. The method of claim 10, further comprising tracking a number of memory cycles for which a request is buffered and scheduling the request according to the number of cycles.

13. The method of claim 10, further comprising prioritizing the requests when the slowdown indexes of the threads become imbalanced relative to the unfairness value.

14. The method of claim 10, wherein the slowdown index is computed based on a real latency value and an ideal latency value for each of the requests.

15. The method of claim 14, further comprising tracking the real latency values and ideal latency values of the requests relative to a time window, and scheduling the requests in a request buffer based on time.

16. The method of claim 10, further comprising selecting a request with a highest slowdown index from all scheduled bank requests.

17. The method of claim 10, further comprising tracking samples and sample hits for an active thread of a processor core.

18. The method of claim 10, further comprising tracking which banks of the shared memory system are ready and which rows of the banks are open.

19. The method of claim 10, further comprising initiating scheduling of the requests when a shared memory bus is ready and at least one memory bank is ready.

20. A memory management system, comprising:
means for receiving memory access requests for threads of a shared memory system;
means for computing a measure that captures memory-related performance slowdown for each of the threads;
means for computing an unfairness value based on the measures; and
means for scheduling the requests based on the unfairness value.
